(19) United States
(12) Patent Application Publication
(10) Pub. No.: US 2019/0130407 A1
(43) Pub. Date: May 2, 2019

(54) REAL-TIME CROSS-CHANNEL FRAUD PROTECTION

(71) Applicant: Brighterion, Inc., Purchase, NY (US)

(72) Inventor: Akli Adjaoute, Mill Valley, CA (US)

(73) Assignee: Brighterion, Inc., Purchase, NY (US)

(21) Appl. No.: 16/226,246

(22) Filed: Dec. 19, 2018

Related U.S. Application Data
(63) Continuation of application No. 14/517,771, filed on Oct. 17, 2014.
Application No. 14/517,771 is a continuation-in-part of application No. 14/454,749, filed on Aug. 8, 2014, now Pat. No. 9,779,407.

(51) Int. Cl. G06Q 20/40; G06N 20/00

(52) U.S. Cl. CPC G06Q 20/4016; G06N 20/00

(57) ABSTRACT

A method of cross-channel fraud management depends on an artificial intelligence machine to execute algorithms for a parallel arrangement of single-channel, fully trained fraud models that each integrate neural networks, case based reasoning, decision trees, genetic algorithms, fuzzy logic, rules and constraints, and smart agents and shared profiles. Specialized vertical business transactional channel payment fraud models are trained by selectively filtering supervised and unsupervised data. Then in real-time transactions and authorization requests coming from many different transactional channels are directed to a corresponding model for fraud detection. A detection of fraud in one channel is added to detections made by models in the other fraud channel models to develop a more complete risk analysis of single accountholders and merchants. Low level, but broad spectrum fraud will be seen as a signal an accountholder has been compromised or there was a wider merchant data breach.

### BACKGROUND OF THE INVENTION

### Field of the Invention

The present invention relates to real-time financial fraud management systems, and more particularly to back-end cross-channel fraud detection and protection systems.

### Background

Financial institutions are ever-increasingly challenged by constantly evolving forms of fraud that are arriving on more fronts than ever. Criminals are continually dreaming up new ways to stay one step ahead of law enforcement. Financial institutions must simultaneously protect their customers from fraud, protect themselves from fraud losses, and comply with increasing complex and difficult regulations and mandates.

Everyone is facing significantly more pressure in authenticating consumers in non-face-to-face channels to protect their brand from vulnerabilities and financial losses from fraud. Accurate fraud detection processes are getting more important than ever as mobile and online channels are used more widely by customers. At the same time, fraudsters' techniques are becoming progressively more sophisticated and have begun using sensitive information and access in one channel to perpetrate frauds in the other channels.

Americans have many different types of on-line accessible accounts and routinely access many different payment products. One such account can be used to move funds to another, and then the second is used to move the funds away. For example a bad check can be deposited to a checking account, and that one used to pay down a credit card balance, which is then run up to the account limits right away.

Few financial institutions are equipped to detect cross-channel fraud, because they simply manage fraud by payment channel, rather than at the customer level. That will not stop fraudsters who comprise one channel, and then complete a bigger fraud on another. Fraud must therefore be tracked from the perspective of the customer being the independent variable.

Whenever there is a risky transaction in one customer relationship, then all the others need to be looked at. Total customer risk involves looking at all of the products a particular customer has with a financial institution. (Better yet, with all even independent institutions.) Understanding customers' relationships allows the real risk to be understood and quickly controlled. A customer who overdrafts and has large assets elsewhere presents a different risk than another who overdrafts and also has a past-due on a line-of-credit. Cross-channel fraud detection becomes possible if data is organized by customer.

Conventional fraud prevention solutions dedicate a standalone system for each of several different channels in a so-called silo-approach. But the silo-approach represents a wasteful duplication of resources, product specialists, operational costs, and investment costs. Silos can limit automated, cohesive sharing of information across channels, and thus can hinder advisory alerts and automated stop payments.

Attempts at fraudulent transactions come from all channels, and are generated by external people and are often mistakenly interpreted as the customer themselves. Fraudulent transaction attempts made by company personnel can include changing customer information, faking contact information, and faking transactions to look as if the customer made them.

Enterprises need to monitor their operations, to both prevent fraud and protect their image. Operational mistakes can be monitored to catch getting higher or lower commissions, fees or making stock purchase orders for more than one day at open market prices, selling foreign currency at higher rate, etc.

### SUMMARY OF THE INVENTION

Briefly, an artificial intelligence cross-channel fraud management embodiment of the present invention comprises a parallel arrangement of single-channel, fully trained fraud models that each integrate several artificial intelligence classifiers like neural networks, case based reasoning, decision trees, genetic algorithms, fuzzy logic, and rules and constraints. These are further integrated by the expert programmers and development system with smart agents and associated real-time profiling, recursive profiles, and long-term profiles. The trainable general payment fraud models are trained into channel specialists with channel-filtered supervised and unsupervised data to produce each channels payment fraud model. This then is applied by a commercial client to process real-time cross-channel transactions and authorization requests for fraud scores.

The above and still further objects, features, and advantages of the present invention will become apparent upon consideration of the following detailed description of specific embodiments thereof, especially when taken in conjunction with the accompanying drawings.

### BRIEF DESCRIPTION OF THE DRAWINGS

FIG. 1 is functional block diagram of an artificial intelligence fraud management solution embodiment of the present invention;

FIG. 2A is functional block diagram of an application development system (ADS) embodiment of the present invention for fraud-based target applications;

FIG. 2B is functional block diagram of an improved and updated application development system (ADS) embodiment of the present invention for fraud-based target applications;

FIG. 3 is functional block diagram of a model training embodiment of the present invention;

FIG. 4 is functional block diagram of a real-time payment fraud management system like that illustrated in FIG. 1 as applied payment fraud model;

FIG. 5 is functional block diagram of a smart agent process embodiment of the present invention;

FIG. 6 is functional block diagram of a most recent 15-minute transaction velocity counter; and

FIG. 7 is functional block diagram of a cross-channel payment fraud management embodiment of the present invention.

### DETAILED DESCRIPTION OF THE INVENTION

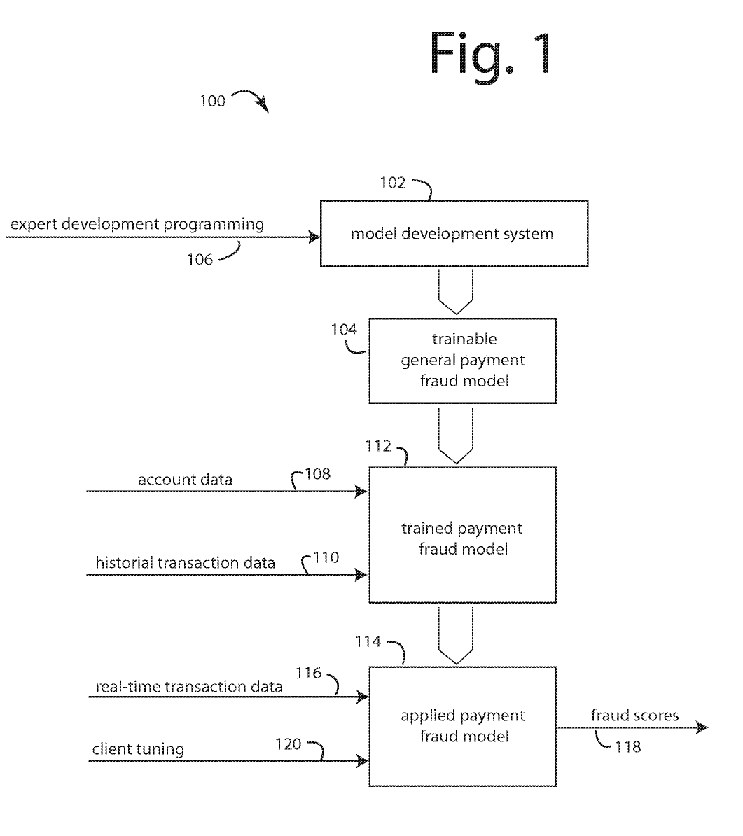

FIG. 1 represents an artificial intelligence fraud management solution embodiment of the present invention, and is referred to herein by the general reference numeral 100. Such solution 100 comprises an expert programmer development system 102 for building trainable general payment fraud models 104 that integrate several, but otherwise blank artificial intelligence classifiers, e.g., neural networks, case based reasoning, decision trees, genetic algorithms, fuzzy logic, and rules and constraints. These are further integrated by the expert programmers inputs 106 and development system 102 to include smart agents and associated real-time profiling, recursive profiles, and long-term profiles.

The trainable general payment fraud models 104 are trained with supervised and unsupervised data 108 and 110 to produce a trained payment fraud model 112. For example, accountholder and historical transaction data. This trained payment fraud model 112 can then be sold as a computer program library or a software-as-a-service applied payment fraud model. This then is applied by a commercial client in an applied payment fraud model 114 to process real-time transactions and authorization requests 116 for fraud scores. The applied payment fraud model 114 is further able to accept a client tuning input 120.

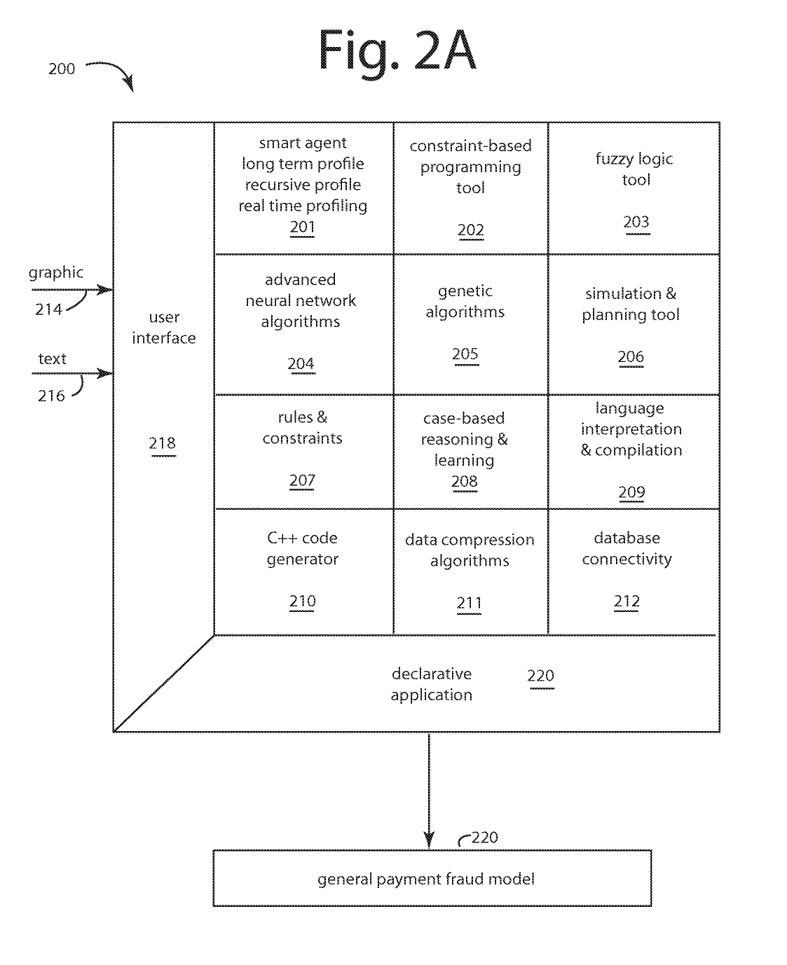

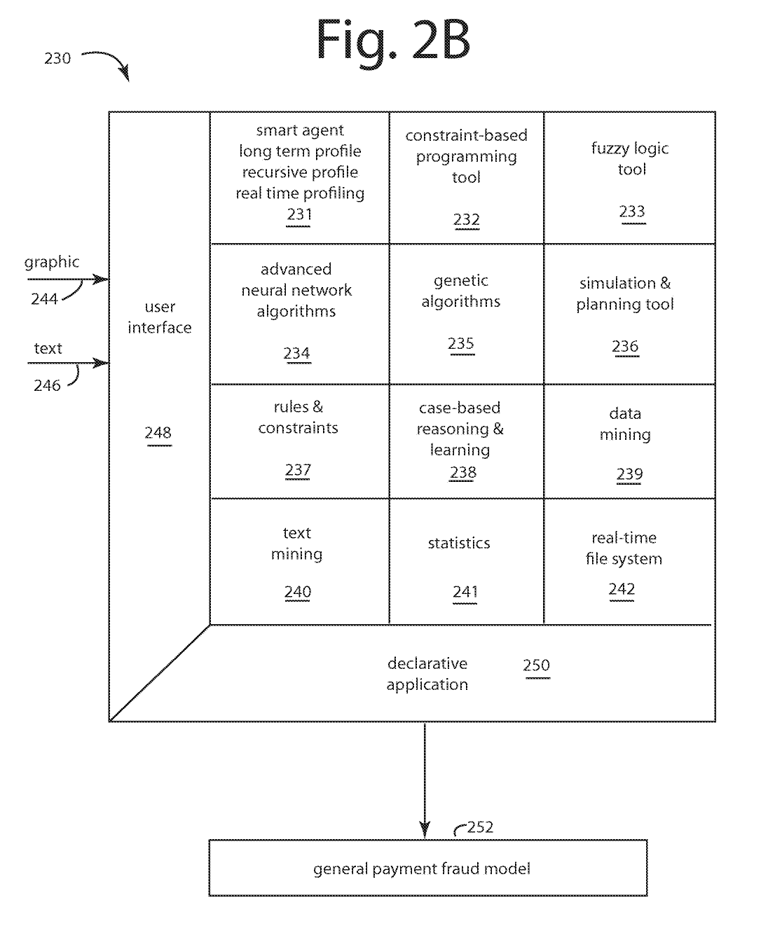

FIG. 2A represents an application development system (ADS) embodiment of the present invention for fraud-based target applications, and is referred to herein by the general reference numeral 200. Such is the equivalent of development system 102 in FIG. 1. ADS 200 comprises a number of computer program development libraries and tools that highly skilled artificial intelligence scientists and artisans can manipulate into a novel combination of complementary technologies. In an early embodiment of ADS 200 we combined a goal-oriented multi-agent technology 201 for building run-time smart agents, a constraint-based programming tool 202, a fuzzy logic tool 203, a library of genetic algorithms 205, a simulation and planning tool 206, a library of business rules and constraints 207, case-based reasoning and learning tools 208, a real-time interpreted language compiler 209, a C++ code generator 210, a library of data compression algorithms 211, and a database connectivity tool 212.

The highly skilled artificial intelligence scientists and artisans provide graphical and textual inputs 214 and 216 to a user interface (UI) 218 to manipulate the novel combinations of complementary technologies into a declarative application 220.

Declarative application 214 is molded, modeled, simulated, tested, corrected, massaged, and unified into a fully functional hybrid combination that is eventually output as a trainable general payment fraud model 222. Such is the equivalent of trainable general payment fraud model 104 in FIG. 1.

It was discovered by the present inventor that the highly skilled artificial intelligence scientists and artisans that could manipulate the complementary technologies mentioned into specific novel combinations required exceedingly talented individuals that were in short supply.

It was, however, possible to build and to prove out that ADS 200 as a compiler would produce trainable general payment fraud models 220, and these were more commercially attractive and viable.

After many years of experimental use and trials, ADS 200 was constantly improved and updated. Database connectivity tool 212, for example, tried to press conventional databases into service during run-time to receive and supply data points in real-time transaction service. It turned out no conventional databases were up to it.

At the present, an updated and improved ADS shown with general reference numeral 230 in FIG. 2B is providing better and more useful trainable general payment fraud models.

ADS 230 is the most recent equivalent of development system 102 in FIG. 1. ADS 230 assembles together a different mix of computer program development libraries and tools for the highly skilled artificial intelligence scientists and artisans to manipulate into a new hybrid of still complementary technologies.

In this later embodiment, ADS 230, we combined an improved smart-agent technology 231 for building run-time smart agents that are essentially only silhouettes of their constituent attributes. These attributes are themselves smart-agents with second level attributes and values that are able to “call” on real-time profilers, recursive profilers, and long term profilers. Such profilers can provide comparative assessments of each data point with the new information flowing in during run-time.

The three profilers can thereafter throw exceptions in each data point category, and the number and quality of exceptions thrown across the breadth of the attributes then incoming will produce a fraud risk score that generally raises exponentially with that number of exceptions thrown. Oracle explains in C++ programming that exceptions provide a way to react to exceptional circumstances (like fraud suspected) in programs by transferring control to special functions called “handlers”.

At the top level of a hierarchy of smart agents linked by their attributes are the smart agents for the independent actors who can engage in fraud. In a payment fraud model, that top level will be the cardholders as tracked by the cardholder account numbers reported in transaction data.

These top level smart agents can call on a moving 15-minute window file that has all the transactions reported to the system in the last 15-minutes. Too much activity in 15-minutes by any one actor is cause for further inspection and analysis.

ADS 230 further comprises a constraint-based programming tool 232, a fuzzy logic tool 233, a library of advanced neural network algorithms 234, a library of genetic algorithms 235, a simulation and planning tool 236, a library of business rules and constraints 237, case-based reasoning and learning tools 238, a data mining tool 239, a text mining tool 240, a statistical tool 241 and a real-time file system 242.

The real-time file system 242 is a simple organization of attribute values for smart agent profilers that allow quick, direct file access.

The highly skilled artificial intelligence scientists and artisans provide graphical and textual inputs 244 and 246 to a user interface (UI) 248 to manipulate the novel combinations of complementary technologies into a declarative application 250.

Declarative application 250 is also molded, modeled, simulated, tested, corrected, massaged, and unified into a fully functional hybrid combination that is eventually output as a trainable general payment fraud model 252. Such is also the more improved equivalent of trainable general payment fraud model 104 in FIG. 1.

The constraint-based programming tools 202 and 232 limit the number of possible solutions. Complex conditions with complex constraints can create an exponential number of possibilities. Fixed constraints, fuzzy constraints, and polynomials are combined in cases where no exact solution exists. New constraints can be added or deleted at any time. The dynamic nature of the tool makes possible real-time simulations of complex plans, schedules, and diagnostics.

The constraint-based programming tools are written as a very complete language in its own right. It can integrate a variety of variables and constraints, as in the following Table.

```
    Variables: Real, with integer values, enumerated, sets,
matrices and vectors, intervals, fuzzy subsets, and more.
    Arithmetic Constraints: =, +, −, *, /, /=, >, <, >=, <=,
interval addition, interval subtraction, interval multiplication
and interval division, max, min, intersection, union,
exponential, modulo, logarithm, and more.
    Temporal (Allen) Constraints: Control allows you to write
any temporal constraints including Equal, N-equal, Before,
After, Meets, Overlaps, Starts, Finishes, and personal temporal
operators such as Disjoint, Started-by, Overlapped-by, Met-by,
Finished-by, and more.
    Boolean Constraints: Or, And, Not, Xor, Implication,
Equivalence
    Symbolic Constraints: Inclusion, Union, Intersection,
Cardinality, Belonging, and more.
```

The constraint-based programming tools 202 and 232 include a library of ways to arrange subsystems, constraints and variables. Control strategies and operators can be defined within or outside using traditional languages such as C, C++, FORTRAN, etc. Programmers do not have to learn a new language, and provides an easy-to-master programming interface by providing an in-depth library and traditional tools.

Fuzzy logic tools 203 and 233 recognize many of the largest problems in organizations cannot be solved by simple yes/no or black/white answers. Sometimes the answers need to be rendered in shades of gray. This is where fuzzy logic proves useful. Fuzzy logic handles imprecision or uncertainty by attaching various measures of credibility to propositions. Such technology enables clear definitions of problems where only imperfect or partial knowledge exists, such as when a goal is approximate, or between all and nothing. In fraud applications, this can equate to the answer being “maybe” fraud is present, and the circumstances warrant further investigation.

Tools 204 and 234 provides twelve different neural network algorithms, including Back propagation, Kohonen, Art, Fuzzy ART, RBF and others, in an easy-to-implement C++ library. Neural networks are algorithmic systems that interpret historical data to identify trends and patterns against which to compare subject cases. The libraries of advanced neural network algorithms can be used to translate databases to neurons without user intervention, and can significantly accelerate the speed of convergence over conventional back propagation, and other neural network algorithms. The present invention's neural net is incremental and adaptive, allowing the size of the output classes to change dynamically. An expert mode in the advanced application development tool suite provides a library of twelve different neural network models for use in customization.

Neural networks can detect trends and patterns other computer techniques are unable to. Neurons work collaboratively to solve the defined problem. Neural networks are adept in areas that resemble human reasoning, making them well suited to solve problems that involve pattern recognition and forecasting. Thus, neural networks can solve problems that are too complex to solve with conventional technologies.

Libraries 205 and 235 include genetic algorithms to initialize a population of elements where each element represents one possible set of initial attributes. Once the models are designed based on these elements, a blind test performance is used as the evaluation function. The genetic algorithm will be then used to select the attributes that will be used in the design of the final models. The component particularly helps when multiple outcomes may achieve the same predefined goal. For instance, if a problem can be solved profitably in any number of ways, genetic algorithms can determine the most profitable way.

Simulation and planning tool 206 can be used during model designs to check the performances of the models.

Business rules and constraints 207 provides a central storage of best practices and know how that can be applied to current situations. Rules and constraints can continue to be captured over the course of years, applying them to the resolution of current problems.

Case-based reasoning 208 uses past experiences in solving similar problems to solve new problems. Each case is a history outlined by its descriptors and the steps that lead to a particular outcome. Previous cases and outcomes are stored and organized in a database. When a similar situation presents itself again later, a number of solutions that can be tried, or should be avoided, will present immediately. Solutions to complex problems can avoid delays in calculations and processing, and be offered very quickly.

Language interpretation tool 209 provides a constant feedback and evaluation loop. Intermediary Code generator 210 translates Declarative Applications 214 designed by any expert into a faster program 230 for a target host 232.

During run-time, real time transaction data 234 can be received and processed according to declarative application 214 by target host 232 with the objective of producing run-time fraud detections 236. For example, in a payments application card payments transaction requests from merchants can be analyzed for fraud activity. In healthcare applications the reports and compensation demands of providers can be scanned for fraud. And in insider trader applications individual traders can be scrutinized for special knowledge that could have illegally helped them profit from stock market moves.

File compression algorithms library 211 helps preserve network bandwidth by compressing data at the user's discretion.

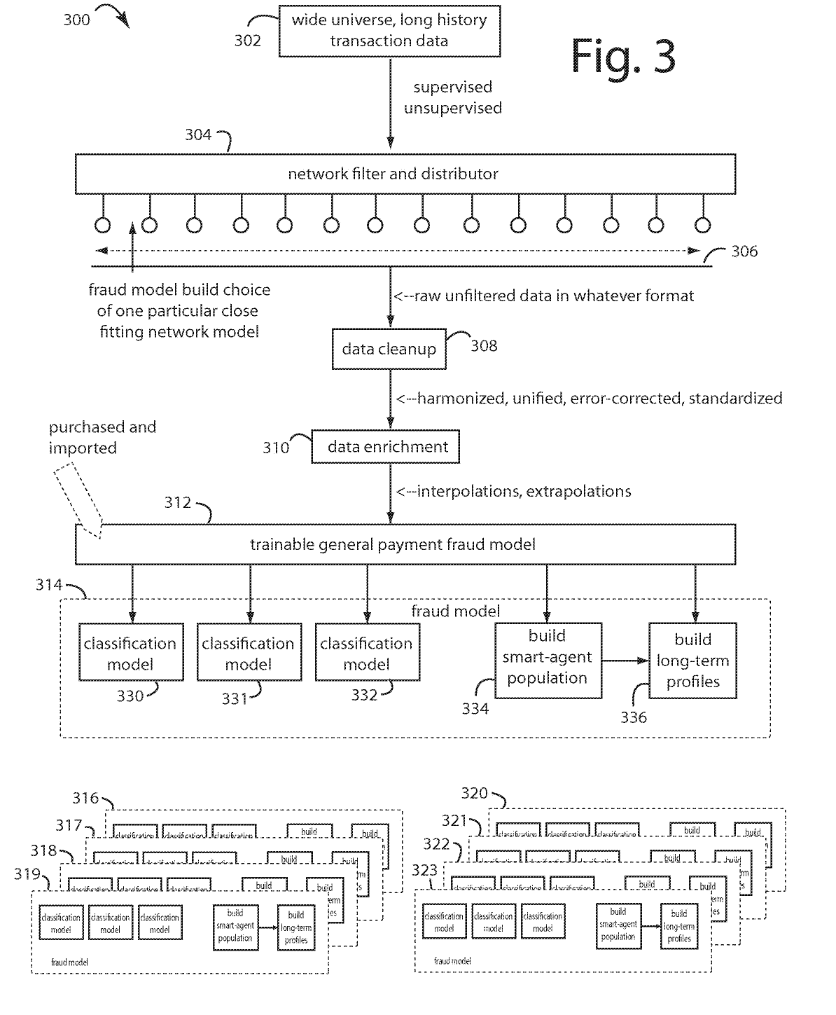

FIG. 3 represents a model training embodiment of the present invention, and is referred to herein by the general reference numeral 300. Model trainer 300 can be fed a very complete, comprehensive transaction history 302 that can include both supervised and unsupervised data. A filter 304 actually comprises many individual filters that can be selected by a switch 306. Each filter can separate the supervised and unsupervised data from comprehensive transaction history 302 into a stream correlated by some factor in each transaction.

The resulting filtered training data will produce a trained model that will be highly specific and sensitive to fraud in the filtered category. When two or more of these specialized trained models used in parallel are combined in other embodiments of the present invention they will excel in real-time cross-channel fraud prevention.

In a payment card fraud embodiment of the present invention, during model training, the filters 304 are selected by switch 306 to filter through dozens of different channels, one-at-a-time for each real-time, risk-scoring channel model that will be needed and later run together in parallel. For example, such channels can include channel transactions and authorization requests for card-not-present, card-present, high risk merchant category code (MCC), micro-merchant, small and medium sized enterprise (SME) finance, international, domestic, debit card, credit card, contactless, or other groupings or financial networks.

The objective here is to detect a first hint of fraud in any channel for a particular accountholder, and to “warn” all the other real-time, risk-scoring channel models that something suspicious is occurring with this accountholder. In one embodiment, the warning comprises an update in the nature of feedback to the real-time, long-term, and recursive profiles for that accountholder so that all the real-time, risk-scoring channel models step up together increment the risk thresholds that accountholder will be permitted. More hits in more channels should translate to an immediate alert and shutdown of all the affected accountholders accounts.

Competitive prior art products make themselves immediately unattractive and difficult to use by insisting that training data suit some particular format. In reality, training data will come from multiple, disparate, dissimilar, incongruent, proprietary data sources simultaneously. A data cleanup process 308 is therefore important to include here to do coherence analysis, and to harmonize, unify, error-correct, and otherwise standardize the heterogeneous data coming from transaction data history 302. The commercial advantage of that is a wide range of clients with many different channels can provide their transaction data histories 302 in whatever formats and file structures are natural to the provider. It is expected that embodiments of the present invention will find applications in financial services, defense and cyber security, health and public service, technology, mobile payments, retail and e-commerce, marketing and social networking, and others.

A data enrichment process 310 computes interpolations and extrapolations of the training data, and expands it out to as many as two-hundred and fifty data points from the forty or so relevant data points originally provided by transaction data history 302.

A trainable fraud model 312 (like that illustrated in FIG. 1 as trainable general payment fraud model 104) is trained into a channel specialized fraud model 314, and each are the equivalent of the applied fraud model 114 illustrated in FIG. 1. The selected training results from the switch 306 setting and the filters 304 then existing.

Channel specialized fraud models 314 can be sold individually or in assorted varieties to clients, and then imported by them as a commercial software app, product, or library.

A variety of selected applied fraud models 316-323 represent the applied fraud models 114 that result with different settings of filter switch 306. Each selected applied fraud model 314 will include a hybrid of artificial intelligence classification models represented by models 330-332 and a smart-agent population build 334 with a corresponding set of real-time, recursive, and long-term profilers 336. The enriched data from data enrichment process 310 is fully represented in the smart-agent population build 334 and profilers 336.

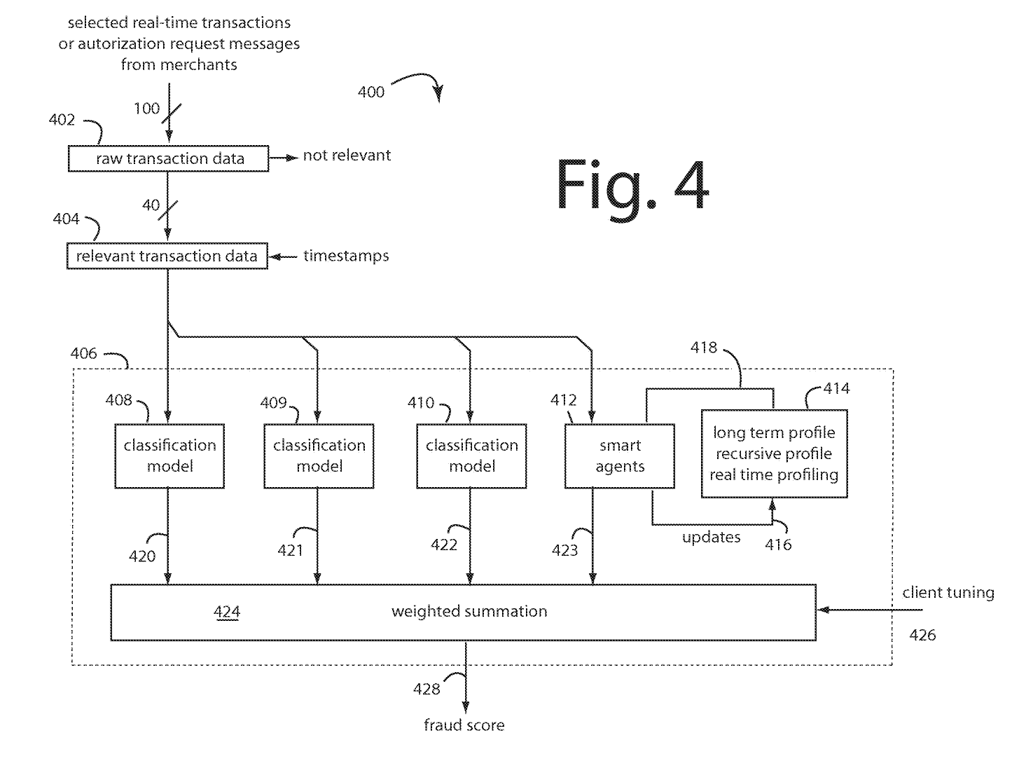

FIG. 4 represents a real-time payment fraud management system 400 like that illustrated in FIG. 1 as applied payment fraud model 114. A raw transaction separator 402 filters through the forty or so data items that are relevant to the computing of a fraud score. A process 404 adds timestamps to these relevant data points and passes them in parallel to a selected applied fraud model 406. This is equivalent to a selected one of applied fraud models 316-323 in FIG. 3 and applied payment fraud model 114 in FIG. 1.

During a session in which the time-stamped relevant transaction data flows in, a set of classification models 408-410 operate independently according to their respective natures. A population of smart agents 412 and profilers 414 also operate on the time-stamped relevant transaction data inflows. Each new line of time-stamped relevant transaction data will trigger an update 416 of the respective profilers 414. Their attributes 418 are provided to the population of smart agents 412.

The classification models 408-410 and population of smart agents 412 and profilers 414 all each produce an independent and separate vote or fraud score 420-423 on the same line of time-stamped relevant transaction data. A weighted summation processor 424 responds to client tunings 426 to output a final fraud score 428.

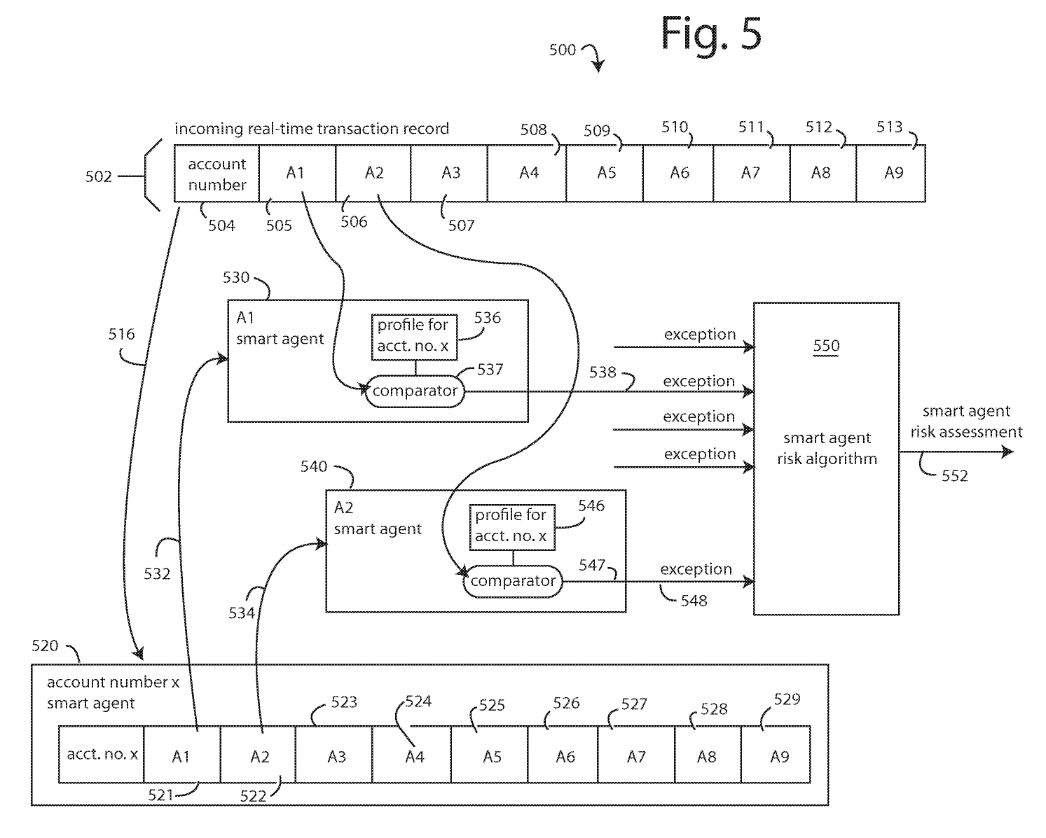

FIG. 5 represents a smart agent process 500 in an embodiment of the present invention. For example, these would include the smart agent population build 334 and profiles 336 in FIG. 3 and smart agents 412 and profiles 414 in FIG. 4. A series of payment card transactions arriving in real-time in an authorization request message is represented here by a random instantaneous incoming real-time transaction record 502.

Such record 502 begins with an account number 504. It includes attributes A1-A9 numbered 505-513 here. These attributes, in the context of a payment card fraud application would include data points for card type, transaction type, merchant name, merchant category code (MCC), transaction amount, time of transaction, time of processing, etc.

Account number 504 in record 502 will issue a trigger 516 to a corresponding smart agent 520 to present itself for action. Smart agent 520 is simply a constitution of its attributes, again A1-A9 and numbered 521-529 in FIG. 5. These attributes A1-A9 521-529 are merely pointers to attribute smart agents. Two of these, one for A1 and one for A2, are represented in FIG. 5. Here, an A1 smart agent 530 and an A2 smart agent 540. These are respectively called into action by triggers 532 and 542.

A1 smart agent 530 and A2 smart agent 540 will respectively fetch correspondent attributes 505 and 506 from incoming real-time transaction record 502. Smart agents for A3-A9 make similar fetches to themselves in parallel. They are not shown here to reduce the clutter for FIG. 5 that would otherwise result.

Each attribute smart agent like 530 and 540 will include or access a corresponding profile data point 536 and 546. This is actually a simplification of the three kinds of profiles 336 (FIG. 3) that were originally built during training and updated in update 416 (FIG. 4). These profiles are used to track what is “normal” behavior for the particular account number for the particular single attribute.

For example, if one of the attributes reports the MCC's of the merchants and another reports the transaction amounts, then if the long-term, recursive, and real time profiles for a particular account number x shows a pattern of purchases at the local Home Depot and Costco that average $100-$300, then an instantaneous incoming real-time transaction record 502 that reports another $200 purchase at the local Costco will raise no alarms. But a sudden, unique, inexplicable purchase for $1250 at a New York Jeweler will and should throw more than one exception.

Each attribute smart agent like 530 and 540 will further include a comparator 537 and 547 that will be able to compare the corresponding attribute in the instantaneous incoming real-time transaction record 502 for account number x with the same attributes held by the profiles for the same account. Comparators 537 and 547 should accept some slack, but not too much. Each can throw an exception 538 and 548, as can the comparators in all the other attribute smart agents. It may be useful for the exceptions to be a fuzzy value, e.g., an analog signal 0.0 to 1.0. Or it could be a simple binary one or zero. What sort of excursions should trigger an exception is preferably adjustable, for example with client tunings 426 in FIG. 4.

These exceptions are collected by a smart agent risk algorithm 550. One deviation or exception thrown on any one attribute being “abnormal” can be tolerated if not too egregious. But two or more should be weighted more than just the simple sum, e.g., (1+1)ⁿ=2ⁿ instead of simply 1+1=2. The product is output as a smart agent risk assessment 552. This output is the equivalent of independent and separate vote or fraud score 423 in FIG. 4.

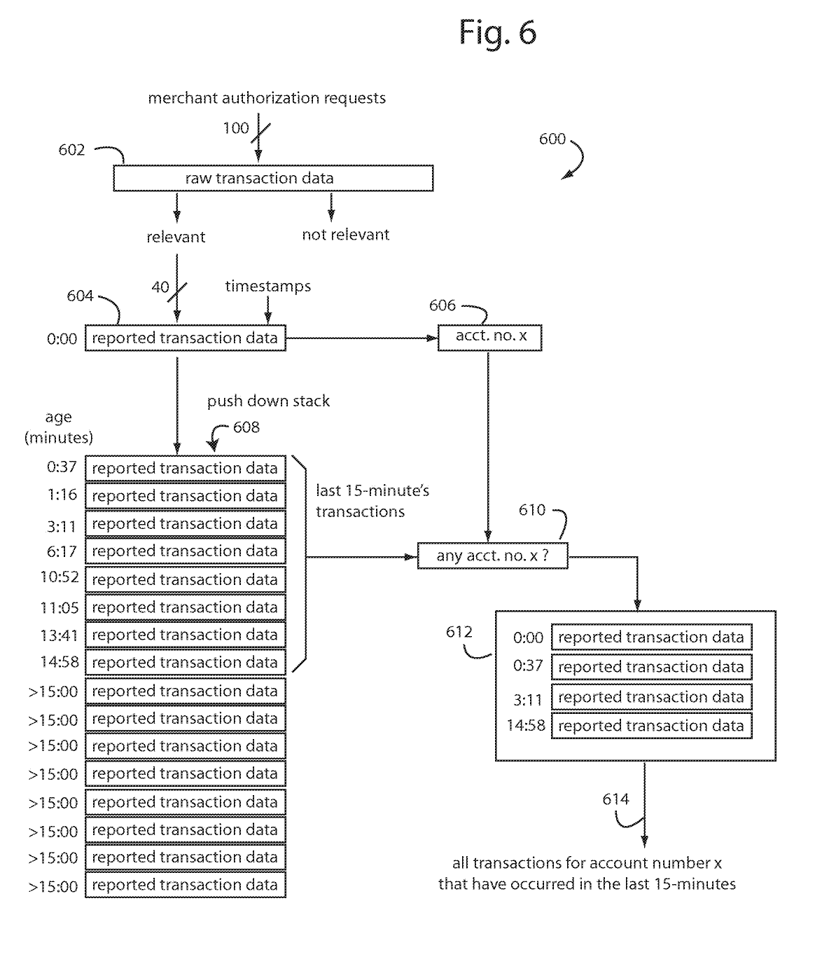

FIG. 6 represents a most recent 15-minute transaction velocity counter 600, in an embodiment of the present invention. It receives the same kind of real-time transaction data inputs as were described in connection with FIG. 4 as raw transaction data 402 and FIG. 5 as records 502. A raw transaction record 602 includes a hundred or so data points. About forty of those data points are relevant to fraud detection an identified in FIG. 6 as reported transaction data 604.

The reported transaction data 604 arrive in a time series and randomly involve a variety of active account numbers. But, let's say the most current reported transaction data 604 with a time age of 0:00 concerns a particular account number x. That fills a register 606.

Earlier arriving reported transaction data 604 build a transaction time-series stack 608. FIG. 6 arbitrarily identifies the respective ages of members of transaction time-series stack 608 with example ages 0:73, 1:16, 3:11, 6:17, 10:52, 11:05, 13:41, and 14:58. Those aged more than 15-minutes are simply identified with ages “>15:00”. This embodiment of the present invention is concerned with only the last 15-minutes worth of transactions. As time passes transaction time-series stack 608 pushes down.

The key concern is whether account number x has been involved in any other transactions in the last 15-minutes. A search process 610 accepts a search key from register 606 and reports any matches in the most 15-minute window with an account activity velocity counter 612. Too much very recent activity can hint there is a fraudster at work, or it may be normal behavior. A trigger 614 is issued that can be fed to an additional attribute smart agent that is included with attributes smart agents 530 and 540 and the others in parallel. Exception from this new account activity velocity counter smart agent is input to smart agent risk algorithm 550 in FIG. 5.

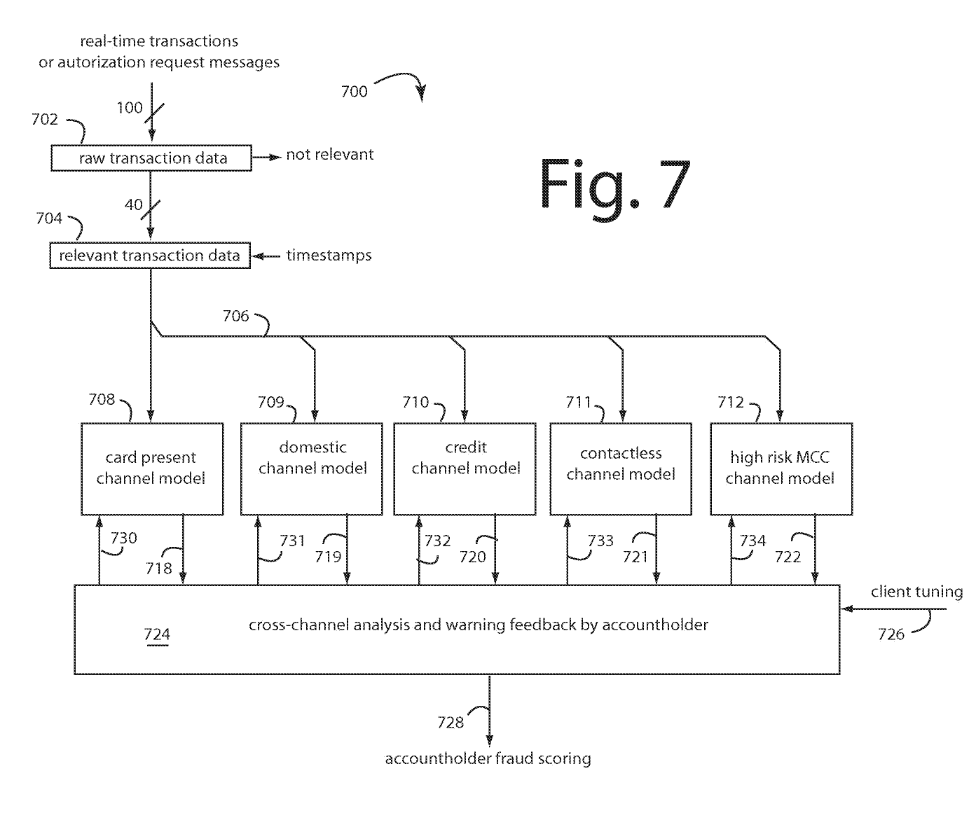

FIG. 7 represents a cross-channel payment fraud management embodiment of the present invention, and is referred to herein by general reference numeral 700.

Real-time cross-channel monitoring uses track cross channel and cross product patterns to cross pollinate information for more accurate decisions. Such track not only the channel where the fraud ends but also the initiating channel to deliver a holistic fraud monitoring. A standalone internet banking fraud solution will allow a transaction if it is within its limits, however if core banking is in picture, then it will stop this transaction, as we additionally know the source of funding of this account (which mostly in missing in internet banking).

In FIG. 3, a variety of selected applied fraud models 316-323 represent the applied fraud models 114 that result with different settings of filter switch 306. A real-time cross-channel monitoring payment network server can be constructed by running several of these selected applied fraud models 316-323 in parallel.

FIG. 7 represents a real-time cross-channel monitoring payment network server 700, in an embodiment of the present invention. Each customer or accountholder of a financial institution can have several very different kinds of accounts and use them in very different transactional channels. For example, card-present, domestic, credit card, contactless, and high risk MCC channels. So in order for a cross-channel fraud detection system to work at its best, all the transaction data from all the channels is funneled into one pipe for analysis.

Real-time transactions and authorization requests data is input and stripped of irrelevant data points by a process 702. The resulting relevant data is time-stamped in a process 704. The 15-minute vector process of FIG. 6 may be engaged at this point in background. A bus 706 feeds the data in parallel line-by-line, e.g., to a selected applied fraud channel model for card present 708, domestic 709, credit 710, contactless 711, and high risk MCC 712. Each can pop an exception to the current line input data with an evaluation flag or score 718-722. The involved accountholder is understood.

These exceptions are collected and analyzed by a process 724 that can issue warning feedback for the profiles maintained for each accountholder. Each selected applied fraud channel model 708-712 shares risk information about particular accountholders with the other selected applied fraud models 708-712. A suspicious or outright fraudulent transaction detected by a first selected applied fraud channel model 708-712 for a particular customer in one channel is cause for a risk adjustment for that same customer in all the other applied fraud models for the other channels.

Exceptions 718-722 to an instant transactions on bus 706 trigger an automated examination of the customer or accountholder involved in a profiling process 724, especially with respect to the 15-minute vectors and activity in the other channels for the instant accountholder. A client tuning input 726 will affect an ultimate accountholder fraud scoring output 728, e.g., by changing the respective risk thresholds for genuine-suspicious-fraudulent.

A corresponding set of warning triggers 73-734 is fed back to all the applied fraud channel models 708-712. The compromised accountholder result 728 can be expected to be a highly accurate and early protection warning.

In general, a process for cross-channel financial fraud protection comprises training a variety of real-time, risk-scoring fraud models with training data selected for each from a common transaction history to specialize each member in the monitoring of a selected channel. Then arranging the variety of real-time, risk-scoring fraud models after the training into a parallel arrangement so that all receive a mixed channel flow of real-time transaction data or authorization requests. The parallel arrangement of diversity trained real-time, risk-scoring fraud models is hosted on a network server platform for real-time risk scoring of the mixed channel flow of real-time transaction data or authorization requests. Risk thresholds are immediately updated for particular accountholders in every member of the parallel arrangement of diversity trained real-time, risk-scoring fraud models when any one of them detects a suspicious or outright fraudulent transaction data or authorization request for the accountholder. So, a compromise, takeover, or suspicious activity of the accountholder's account in any one channel is thereafter prevented from being employed to perpetrate a fraud in any of the other channels.

Such process for cross-channel financial fraud protection can further comprise steps for building a population of real-time and a long-term and a recursive profile for each the accountholder in each the real-time, risk-scoring fraud models. Then during real-time use, maintaining and updating the real-time, long-term, and recursive profiles for each accountholder in each and all of the real-time, risk-scoring fraud models with newly arriving data. If during real-time use a compromise, takeover, or suspicious activity of the accountholder's account in any one channel is detected, then updating the real-time, long-term, and recursive profiles for each accountholder in each and all of the other real-time, risk-scoring fraud models to further include an elevated risk flag. The elevated risk flags are included in a final risk score calculation 728 for the current transaction or authorization request.

The 15-minute vectors described in FIG. 6 are a way to cross pollenate risks calculated in one channel with the others. The 15-minute vectors can represent an amalgamation of transactions in all channels, or channel-by channel. Once a 15-minute vector has aged, it can be shifted into a 30-minute vector, a one-hour vector, and a whole day vector by a simple shift register means. These vectors represent velocity counts that can be very effective in catching fraud as it is occurring in real time.

In every case, embodiments of the present invention include adaptive learning that combines three learning techniques to evolve the artificial intelligence classifiers, e.g., 408-414. First is the automatic creation of profiles, or smart-agents, from historical data, e.g., long-term profiling. See FIG. 3. The second is real-time learning, e.g., enrichment of the smart-agents based on real-time activities. See FIG. 4. The third is adaptive learning carried by incremental learning algorithms. See FIG. 7.

For example, two years of historical credit card transactions data needed over twenty seven terabytes of database storage. A smart-agent is created for each individual card in that data in a first learning step, e.g., long-term profiling. Each profile is created from the card's activities and transactions that took place over the two year period. Each profile for each smart-agent comprises knowledge extracted field-by-field, such as merchant category code (MCC), time, amount for an mcc over a period of time, recursive profiling, zip codes, type of merchant, monthly aggregation, activity during the week, weekend, holidays, Card not present (CNP) versus card present (CP), domestic versus cross-border, etc. this profile will highlights all the normal activities of the smart-agent (specific card).

Smart-agent technology has been observed to outperform conventional artificial and machine learning technologies. For example, data mining technology creates a decision tree from historical data. When historical data is applied to data mining algorithms, the result is a decision tree. Decision tree logic can be used to detect fraud in credit card transactions. But, there are limits to data mining technology. The first is datamining can only learn from historical data and it generates decision tree logic that applies to all the cardholders as a group. The same logic is applied to all cardholders even though each merchant may have a unique activity pattern and each cardholder may have a unique spending pattern.

A second limitation is decision trees become immediately outdated. Fraud schemes continue to evolve, but the decision tree was fixed with examples that do not contain new fraud schemes. So stagnant non-adapting decision trees will fail to detect new types of fraud, and do not have the ability to respond to the highly volatile nature of fraud.

Another technology widely used is “business rules” which requires actual business experts to write the rules, e.g., if-then-else logic. The most important limitations here are that the business rules require writing rules that are supposed to work for whole categories of customers. This requires the population to be sliced into many categories (students, seniors, zip codes, etc.) and asks the experts to provide rules that apply to all the cardholders of a category.

How could the US population be sliced? Even worse, why would all the cardholders in a category all have the same behavior? It is plain that business rules logic has built-in limits, and poor detection rates with high false positives. What should also be obvious is the rules are outdated as soon as they are written because conventionally they don't adapt at all to new fraud schemes or data shifts.

Neural network technology also limits, it uses historical data to create a matrix weights for future data classification. The Neural network will use as input (first layer) the historical transactions and the classification for fraud or not as an output). Neural Networks only learn from past transactions and cannot detect any new fraud schemes (that arise daily) if the neural network was not re-trained with this type of fraud. Same as data mining and business rules the classification logic learned from the historical data will be applied to all the cardholders even though each merchant has a unique activity pattern and each cardholder has a unique spending pattern.

Another limit is the classification logic learned from historical data is outdated the same day of its use because the fraud schemes changes but since the neural network did not learn with examples that contain this new type of fraud schemes, it will fail to detect this new type of fraud it lacks the ability to adapt to new fraud schemes and do not have the ability to respond to the highly volatile nature of fraud.

Contrary to previous technologies, smart-agent technology learns the specific behaviors of each cardholder and create a smart-agent that follow the behavior of each cardholder. Because it learns from each activity of a cardholder, the smart-agent updates the profiles and makes effective changes at runtime. It is the only technology with an ability to identify and stop, in real-time, previously unknown fraud schemes. It has the highest detection rate and lowest false positives because it separately follows and learns the behaviors of each cardholder.

Smart-agents have a further advantage in data size reduction. Once, say twenty-seven terabytes of historical data is transformed into smart-agents, only 200-gigabytes is needed to represent twenty-seven million distinct smart-agents corresponding to all the distinct cardholders.

Incremental learning technologies are embedded in the machine algorithms and smart-agent technology to continually re-train from any false positives and negatives that occur along the way. Each corrects itself to avoid repeating the same classification errors. Data mining logic incrementally changes the decision trees by creating a new link or updating the existing links and weights. Neural networks update the weight matrix, and case based reasoning logic updates generic cases or creates new ones. Smart-agents update their profiles by adjusting the normal/abnormal thresholds, or by creating exceptions.

Although particular embodiments of the present invention have been described and illustrated, such is not intended to limit the invention. Modifications and changes will no doubt become apparent to those skilled in the art, and it is intended that the invention only be limited by the scope of the appended claims.

1. A computer-implemented method for real-time cross-channel transaction fraud vetting, comprising:
automatically receiving, at one or more processors, a first transaction record corresponding to a first transaction channel and including first real-time transaction data;
automatically retrieving, via the one or more processors, a plurality of datapoints corresponding to a first plurality of profiles of the transacting entity, each datapoint representing a standard for a corresponding data attribute computed from historical transaction records of the transacting entity within the first transaction channel;
automatically determining, via the one or more processors, whether deviation of the first real-time transaction data from each datapoint of the first plurality of profiles exceeds a corresponding threshold;
automatically generating, via the one or more processors, an exception for the first transaction record for each deviation from one of the datapoints of the first plurality of profiles that exceeds the corresponding threshold;
automatically determining, via the one or more processors, a first fraud score for the first transaction record based at least in part on any exceptions generated from the first real-time transaction data;
automatically generating, via the one or more processors and based at least in part on any exceptions generated from the first real-time transaction data, adjusted thresholds corresponding to a second plurality of profiles of the transacting entity, each of the second plurality of profiles being associated with a datapoint representing a standard for a corresponding data attribute computed from historical transaction records of the transacting entity within a second transaction channel;
automatically receiving, at the one or more processors, a second transaction record corresponding to the second transaction channel and including second real-time transaction data;
automatically determining, via the one or more processors, whether deviation of the second real-time transaction data from each datapoint of the second plurality of profiles exceeds the corresponding adjusted threshold;
automatically generating, via the one or more processors, an exception for the second transaction record for each deviation from one of the datapoints of the second plurality of profiles that exceeds the corresponding adjusted threshold; and
automatically determining, via the one or more processors, a second fraud score for the second transaction record based at least in part on any exceptions generated from the second real-time transaction data.

2. The computer-implemented method of claim 1, further comprising automatically updating, via the one or more processors, at least one of the datapoints corresponding to the first plurality of profiles based on the first real-time transaction data to generate an updated datapoint set for the first plurality of profiles.

3. The computer-implemented method of claim 2, further comprising—
automatically receiving, at the one or more processors, a third transaction record corresponding to the first transaction channel, the third transaction record including third real-time transaction data;
automatically determining, via the one or more processors, whether deviation of the third real-time transaction data from each datapoint of the updated datapoint set exceeds the corresponding threshold;
automatically generating, via the one or more processors, an exception for the third transaction record for each deviation from one of the datapoints of the updated datapoint set that exceeds the corresponding threshold; and
automatically determining, via the one or more processors, a third fraud score for the third transaction record based at least in part on any exceptions generated from the third real-time transaction data.

4. The computer-implemented method of claim 1, further comprising—
automatically timestamping, via the one or more processors, the first transaction record and the second transaction record;
automatically executing, via the one or more processors, a velocity counter having a pre-defined moving time window encompassing the timestamps of the first transaction record and the second transaction record;
automatically determining, via the one or more processors, a total number of transactions within the pre-defined moving time window by adding the first transaction record and the second transaction record to any other transactions of the transacting entity occurring within the pre-defined moving time window;
automatically determining, via the one or more processors, whether the total number of transactions occurring within the pre-defined moving time window exceeds a corresponding threshold and, if so, automatically generating a warning.

5. The computer-implemented method of claim 1, wherein—
a bus is configured to receive transaction records, including the first transaction record and the second transaction record, and automatically feed the transaction records line-by-line in real-time and in parallel to first and second applied fraud models respectively incorporating the first and second pluralities of profiles.

6. The computer-implemented method of claim 5, wherein—
each of the first and second applied fraud models also includes at least one artificial intelligence classifier constructed according to one of: a neural network, case based reasoning, a decision tree, a genetic algorithm, fuzzy logic, and rules and constraints,
a process executed by the one or more processors is configured to cause the one or more processors to receive the real-time transaction data of each of the first and second transaction records, automatically strip the real-time transaction data to remove irrelevant data, and automatically feed the stripped real-time transaction data in real-time and in parallel to the first and second applied fraud models.

7. The computer-implemented method of claim 6, wherein, for each transaction record and corresponding applied fraud model, each at least one artificial intelligence classifier independently computes a supplemental fraud score, further comprising—
automatically receiving, via the one or more processors, each supplemental fraud score from the at least one artificial intelligence classifier of the corresponding applied fraud model;
automatically receiving, via the one or more processors, the fraud score based at least in part on the plurality of profiles of the corresponding applied fraud model;
automatically computing, via the one or more processors, a final fraud score for the transaction record using a weighted summation based on the fraud score of the plurality of profiles and the supplemental fraud scores of the corresponding applied fraud model.

8. The computer-implemented method of claim 7, wherein—
automatically computing the final fraud score includes automatically retrieving, via the one or more processors, one or more user-tuned weighting adjustments,
automatically computing the final fraud score includes incorporating the weighting adjustments into the weighted summation.

9. The computer-implemented method of claim 6, further comprising—
automatically re-training the at least one artificial intelligence classifier based at least in part on one or more of false positives and false negatives.

10. The computer-implemented method of claim 1, further comprising—
automatically receiving, at the one or more processors, a third transaction record corresponding to the first transaction channel and including third real-time transaction data;
automatically determining, via the one or more processors, that the third transaction record is of a second transacting entity without a plurality of profiles for the first transaction channel;
automatically generating, via the one or more processors, a third plurality of profiles corresponding to the first transaction channel and the second transacting entity.

11. A monitoring payment network server for real-time transaction fraud vetting, comprising:
one or more processors;
a bus configured to feed at least parts of transaction records in parallel line-by-line to profiles; and
non-transitory computer-readable storage media having computer-executable instructions stored thereon, wherein when executed by the one or more processors the computer-readable instructions cause the one or more processors to—
automatically receive a first transaction record corresponding to a first transaction channel and including first real-time transaction data;
automatically retrieve a plurality of datapoints corresponding to a first plurality of profiles of the transacting entity, each datapoint representing a standard for a corresponding data attribute computed from historical transaction records of the transacting entity within the first transaction channel;
automatically determine whether deviation of the first real-time transaction data from each datapoint of the first plurality of profiles exceeds a corresponding threshold;
automatically generate an exception for the first transaction record for each deviation from one of the datapoints of the first plurality of profiles that exceeds the corresponding threshold;
automatically determine a first fraud score for the first transaction record based at least in part on any exceptions generated from the first real-time transaction data;
automatically generate, based at least in part on any exceptions generated from the first real-time transaction data, adjusted thresholds corresponding to a second plurality of profiles of the transacting entity, each of the second plurality of profiles being associated with a datapoint representing a standard for a corresponding data attribute computed from historical transaction records of the transacting entity within a second transaction channel;
automatically receive a second transaction record corresponding to the second transaction channel and including second real-time transaction data;
automatically determine whether deviation of the second real-time transaction data from each datapoint of the second plurality of profiles exceeds the corresponding adjusted threshold;
automatically generate an exception for the second transaction record for each deviation from one of the datapoints of the second plurality of profiles that exceeds the corresponding adjusted threshold; and
automatically determine a second fraud score for the second transaction record based at least in part on any exceptions generated from the second real-time transaction data.

12. The payment processing server of claim 11, wherein the computer-readable instructions further cause the one or more processors to automatically update at least one of the datapoints corresponding to the first plurality of profiles based on the first real-time transaction data to generate an updated datapoint set for the first plurality of profiles.

13. The payment processing server of claim 12, wherein the computer-readable instructions further cause the one or more processors to—
automatically receive a third transaction record corresponding to the first transaction channel, the third transaction record including third real-time transaction data;
automatically determine whether deviation of the third real-time transaction data from each datapoint of the updated datapoint set exceeds the corresponding threshold;
automatically generate an exception for the third transaction record for each deviation from one of the datapoints of the updated datapoint set that exceeds the corresponding threshold; and
automatically determine a third fraud score for the third transaction record based at least in part on any exceptions generated from the third real-time transaction data.

14. The payment processing server of claim 11, wherein the computer-readable instructions further cause the one or more processors to—
automatically timestamp the first transaction record and the second transaction record;
automatically execute a velocity counter having a pre-defined moving time window encompassing the timestamps of the first transaction record and the second transaction record;
automatically determine a total number of transactions within the pre-defined moving time window by adding the first transaction record and the second transaction record to any other transactions of the transacting entity occurring within the pre-defined moving time window;
automatically determine whether the total number of transactions occurring within the pre-defined moving time window exceeds a corresponding threshold and, if so, automatically generate a warning.

15. The payment processing server of claim 11, wherein the computer-readable instructions further cause the one or more processors to—
automatically generate, based at least in part on the first and second fraud scores, an ultimate accountholder fraud scoring output.

16. The payment processing server of claim 11, wherein—
the first and second pluralities of profiles are respectively included within first and second applied fraud models,
each of the first and second applied fraud models also includes at least one artificial intelligence classifier constructed according to one of: a neural network, case based reasoning, a decision tree, a genetic algorithm, fuzzy logic, and rules and constraints,
a process executed by the one or more processors is configured to cause the one or more processors to receive the real-time transaction data of each of the first and second transaction records, automatically strip the real-time transaction data to remove irrelevant data, and automatically feed the stripped real-time transaction data in real-time and in parallel to the first and second applied fraud models.

17. The payment processing server of claim 16, wherein, for each transaction record and corresponding applied fraud model, each at least one artificial intelligence classifier independently computes a supplemental fraud score, wherein the computer-readable instructions further cause the one or more processors to—
automatically receive each supplemental fraud score from the at least one artificial intelligence classifier of the corresponding applied fraud model;
automatically receive the fraud score based at least in part on the plurality of profiles of the corresponding applied fraud model;
automatically compute a final fraud score for the transaction record using a weighted summation based on the fraud score of the plurality of profiles and the supplemental fraud scores of the corresponding applied fraud model.

18. The payment processing server of claim 17, wherein—
automatically computing the final fraud score includes automatically retrieving one or more user-tuned weighting adjustments,
automatically computing the final fraud score includes incorporating the weighting adjustments into the weighted summation.

19. The payment processing server of claim 16, wherein the computer-readable instructions further cause the one or more processors to—
automatically re-train the at least one artificial intelligence classifier based at least in part on one or more of false positives and false negatives.

20. The payment processing server of claim 11, wherein the computer-readable instructions further cause the one or more processors to—
automatically receive a third transaction record corresponding to the first transaction channel and including third real-time transaction data;
automatically determine that the third transaction record is of a second transacting entity without a plurality of profiles for the first transaction channel;
automatically generate a third plurality of profiles corresponding to the first transaction channel and the second transacting entity.
